(19) United States
(12) Patent Application Publication
(10) Pub. No.: US 2022/0155414 A1
(43) Pub. Date: May 19, 2022

(54) METHOD FOR THE IDENTIFICATION OF OBJECTS IN A WAREHOUSE USING AN INDUSTRIAL TRUCK

(71) Applicant: Jungheinrich Aktiengesellschaft, Hamburg (DE)

(72) Inventors: Hannes Bistry, Pinneberg (DE); Ralf Wetegrove, Norderstedt (DE)

(73) Assignee: Jungheinrich Aktiengesellschaft, Hamburg (DE)

(21) Appl. No.: 17/528,465

(22) Filed: Nov. 17, 2021

(30) Foreign Application Priority Data
Nov. 17, 2020 (DE) 10 2020 130 280.0

(51) Int. Cl. G01S 7/48; G05D 1/02

(52) U.S. Cl. CPC G01S 7/4802; G05D 2201/0216; G05D 1/0223

(57) ABSTRACT

A method for identifying objects in a warehouse comprises emitting an identification signal into an environment using a transmitting apparatus. Reflected identification signals by objects in the environment are detected as a signal echo using a receiving apparatus. A solid angle and a receiving time are assigned to each of the signal echoes. It is then determined whether a same solid angle has been assigned to a plurality of signal echoes, and if so, then for those plurality of signal echoes, the signal echo which arrived last in the receiving apparatus according to a receiving time is evaluated. The object is then identified based on the evaluated signal echoes.

### CROSS REFERENCE TO RELATED INVENTION

This application is based upon and claims priority to, under relevant sections of 35 U.S.C. § 119, German Patent Application No. 10 2020 130 280.0, filed Nov. 17, 2020, the entire contents of which are hereby incorporated by reference.

### FIELD OF TECHNOLOGY

This disclosure relates to a method for the identification of objects in a warehouse by means of an industrial truck, as well as an industrial truck configured to carry out the method.

### BACKGROUND

Industrial trucks generally comprise a plurality of sensors for the identification of their environment, such as for example laser scanners. Objects in the environment of the industrial truck may be identified by means of these sensors and the industrial truck may be steered on the basis of the identified objects, for example the industrial truck may be steered around the obstacle in the case of an object identified as an obstacle. For example, a load carrier to be picked up, such as a pallet, may also be identified in this manner and subsequently picked up by the industrial truck.

An identification method which is relevant thereto is disclosed in EP 3 316 181 A1. In this method, on the basis of data recorded by a 3D camera, a view of an object located in the vicinity of the industrial truck is generated and compared with a template, i.e. a predefined pattern. The template may be stored in an evaluation apparatus of the industrial truck. During this so-called template matching it is possible to monitor whether the image recorded by the 3D camera, for example of a pallet, sufficiently corresponds to the stored image of the pallet as a template. In the case of sufficient correspondence, the object is identified as a pallet. The industrial truck may then pick up the pallet, in particular automatically, by driving the load-carrying fork of the industrial truck into the pallet pockets and subsequently lifting.

In known methods it may arise that the object identification fails. This is the case, for example, when the detected view of the pallet does not sufficiently correspond to the template during the described template matching. As the inventors have recognized, this occurs in particular when a load arranged on the pallet is wrapped around with a partially transparent film wrapping. Films are frequently used in logistics for fixing loads. At the same time, it regularly occurs that the film wrapping also at least partially conceals the pallet pockets. The recorded image of the pallet then potentially deviates too greatly from the template.

During the course of the object identification, for example, instead of a pallet a free space may also be identified inside a storage rack as the object. Such an identification may also fail when, for example, films from a rack level located thereabove hang into the free space located therebelow. A partially transparent strip curtain, by which the different warehouse regions may be separated from one another, may also prevent objects which are located behind the strip curtain from being successfully identified as an obstacle. In particular, this strip curtain may constitute an apparent obstacle even if it might be possible to drive through said strip curtain when used as intended.

Obstacle identification in road traffic by means of LIDAR systems is also disclosed, for example, in WO 2019/164959 A1, WO 2019/226487 A1 or WO 2019/222684 A1. These LIDAR systems emit laser pulses and evaluate the echoes over the course of time or, respectively, reduce the signal-to-noise ratio by repeated measurements. Thus, obstacles which are concealed by fog or smoke are also intended to be identified.

Proceeding from this prior art, the object of the invention is to provide a method or, respectively, an industrial truck by which objects may be identified in a more reliable manner in a warehouse. In particular, the objects are intended to be identified in spite of being concealed by at least partially transparent obstacles.

### BRIEF SUMMARY OF THE INVENTION

An embodiment of a method for the identification of objects in a warehouse by means of an industrial truck comprises emitting an identification signal by means of a transmitting apparatus of the industrial truck. The identification signal reflected by objects in the environment is detected as a signal echo by means of a receiving apparatus of the industrial truck. A solid angle and a receiving time is assigned to each of the signal echoes and then monitored to see whether the same solid angle has been assigned to a plurality of signal echoes. If a plurality of signal echoes have been assigned to a solid angle, then the signal echo which arrived last is evaluated in the receiving apparatus according to the receiving time for this solid angle for the identification of the object. The object is then identified on the basis of the signal echoes.

An embodiment of an industrial truck is disclosed that is configured to employ the method of identifying objects in a warehouse. The method according to the invention may thus be carried out by the industrial truck according to the disclosure. Descriptions made relative to the method accordingly apply to the industrial truck, in particular to the evaluation apparatus, and vice versa.

In an embodiment, the industrial truck comprises a transmitting apparatus for emitting an identification signal, a receiving apparatus for detecting the identification signal as a signal echo reflected by objects in the environment, as well as an evaluation apparatus. The evaluation apparatus is configured to assign a solid angle and a receiving time to each of the signal echoes, to monitor whether the same solid angle has been assigned to a plurality of signal echoes. When a plurality of signal echoes have been assigned to a solid angle, the evaluation apparatus is configured to evaluate the signal echo which arrived last in the receiving apparatus according to the receiving time for this solid angle, i.e. to form the basis of the identification of the object, to identify the object on the basis of the signal echoes, and to steer the industrial truck on the basis of the identified object.

In an embodiment, an object identification takes place by emitting identification signals and evaluating signal echoes. The identification signal may be, for example, an optical signal, in particular a laser signal. The transmitting apparatus and receiving apparatus may be part of a common transceiving apparatus, in particular a sensor unit. For example, a LIDAR (“light detection and ranging”) system may be provided as the transceiving apparatus, which outputs two-dimensional environmental data or even depth information comprising three-dimensional environmental data. A “time of flight” camera may also be provided. The identification signal, however, may also be an acoustic signal, in particular an ultrasonic signal. As a result, the environment may be detected by means of an ultrasound sensor system.

In an embodiment, a solid angle as well as a receiving time are assigned to each of the signal echoes received by the receiving apparatus. Thus, a view of the environment of the industrial truck, in particular an object located in the environment of the industrial truck, may be generated. For example, it may be a two-dimensional view. A three-dimensional view may also be generated by considering distance information. Distance information may be derived, in particular, by considering the transmission time of the identification signal as well as the running time of the signals.

The inventors have recognized that partially transparent obstacles in the environment of the industrial truck may lead to a plurality of signal echoes appearing at one and the same solid angle. Thus, when the emitted identification signal encounters the partially transparent obstacle, a part of the signal may be reflected and thus arrive in the receiving apparatus as a first signal echo, whilst a part of the identification signal transmitted by the partially transparent obstacle is reflected on an object located therebehind, for example a pallet, and is received in the receiving apparatus as a second signal echo coming from the same solid angle and arriving later. In the case of the known method described in the introduction for the identification of objects, this may lead to the partially transparent object being identified rather than the object located therebehind. If, for example as described in the introduction, a pallet is intended to be identified as the object, the film possibly hanging in front of the pallet pockets for fixing the load arranged on the pallet may prevent the identification of the pallet located therebehind, viewed from the industrial truck.

In the case where the same solid angle has been assigned to a plurality of signal echoes, the solution according to the invention provides that the signal echo, which arrived last in the receiving apparatus for the respective solid angle, is evaluated for the identification of the object. The evaluation of the signal echo which arrived last for the respective solid angle for the identification of the object may mean that the last signal echo is assigned to the object. In particular, the last signal echo may be exclusively assigned to the object. Previously arrived signal echoes for the same solid angle may be ignored during the evaluation, for example. Moreover, previously arrived signal echoes may form the basis of an identification of the partially transparent object, as is described below in more detail. Moreover, the evaluation of the signal echo which arrived last for the respective solid angle for the identification of the object may mean that for this solid angle a signal echo which previously entered the receiving apparatus is replaced or that none of the signal echoes which entered the receiving apparatus at the same solid angle is assigned to the object. Thus, for example, during the course of the evaluation a pixel based on a previous signal echo may be deleted on the basis of a further signal echo at the same solid angle, as is described below in more detail. By the evaluation of the signal echoes which arrived last for the identification of the object, therefore, a pallet may also be reliably identified, for example, if the pallet pockets thereof are partially or entirely covered by a transparent film. The transparent film is “seen through”. The industrial truck may then be steered on the basis of the object thus identified.

Thus, for example, in the case of an identified pallet the industrial truck may drive, in particular fully automatically, with the load-carrying fork into the pallet pockets and at the same time puncture the transparent film with the fork tines. In addition, for example, when identifying a free space in a rack, transparent film protruding into the free space may be ignored. A partially transparent strip curtain may also be ignored and thus driven through by the industrial truck, in particular fully automatically. The industrial truck is able to see through the strip curtain and reliably identify objects located therebehind, for example the substrate to be driven over by the industrial truck or a potential obstacle, such as another industrial truck. The solution according to the invention is particularly simple and efficient due to the assignment of the signal echo from the object which in principle arrived last, in particular compared to methods which carry out an assignment via the comparison with known pulse shapes of the signal echoes. Thus, for the solution according to the invention, no knowledge is required about known pulse shapes. Indeed, the accurate pulse shape of the signal echo may be irrelevant, since instead it depends on the receiving time.

In an embodiment, the receiving apparatus may, in particular, permanently measure and thus detect a plurality of successive signal echoes. The receiving apparatus may be activated for a predetermined time period after the emission of the identification signal by the transmitting apparatus. Thus, according to one embodiment it may be provided that only signal echoes which arrive in the receiving apparatus within a predetermined time period after the emission of the identification signal are used or evaluated for the identification of the object. According to a further embodiment which is relevant thereto, the predetermined time period may be based on a maximum measuring distance to be anticipated. This increases the probability that the signal echoes arriving at the receiving apparatus are also actually signal echoes of the emitted identification signals. This is relevant, in particular, when the signal echoes which arrived last at the receiving apparatus form the basis of the object identification according to the invention. The limit to a time period dependent on a maximum measuring distance to be anticipated may prevent measuring signals arriving later (caused for example by repeated reflections) from forming the basis of the object identification, which could lead to a faulty object identification. In particular, the object actually to be identified could be overlooked.

According to one embodiment, the object is identified by generating a view of the object on the basis of the signal echoes and comparing the view with a template, wherein in the case of sufficient correspondence between the view and the template the object is regarded as identified. As a result, as mentioned in the introduction, a template matching may be carried out. Thus, for example, a view of a pallet front may be generated from the signal echoes. This image of the rack front may then be compared with a stored template, i.e. a pattern image, of a pallet front by means of the evaluation apparatus of the industrial truck. With sufficient correspondence between the view and template, the industrial truck identifies the pallet and is able to pick up this pallet. The view may be generated in this case by the respective last signal echoes being assigned to the object, previous signal echoes at the same solid angle, however, being ignored as already discussed above. The object, therefore, may exclusively be identified on the basis of the signal echoes which arrived last. Moreover, previously arrived signal echoes may additionally form the basis of the identification of the object. Thus, for example based on the first signal echoes, initially pixels may be generated for the view, in particular an image of the entire rack front. Subsequently, for the solid angles at which a further last signal echo arrives, the respective pixel may be deleted or, respectively, replaced.

According to an embodiment which is relevant thereto, the view of the object is generated by creating a two-dimensional data set by projecting pixels onto a projection plane. The signal echoes detected by the receiving apparatus may in this case be understood as image data which comprise a plurality of pixels. Point clouds are also referred to here. These pixels are projected onto the projection plane. The projection plane may be preferably selected such that it corresponds to an assumed arrangement of the object to be identified. The pixels distributed over the projection plane may be understood as a two-dimensional view of the object. A three-dimensional object identification is also possible. In this case, according to a further embodiment it may be provided that a further data set which comprises a depth profile along a line at the position of the projection plane is created, and that the further data set is compared with a predefined depth profile pattern assigned to the object, wherein the object is finally identified when a sufficient correspondence is established during this comparison. According to this embodiment, therefore, a further template matching takes place. The reliability of the identification thus may be increased. Relative to further details for such a template matching, reference is made to EP 3 316 181 A1.

Should the signal echo which arrived last, i.e. the signal echo generated by an object located behind an assumed transparent object, only differ slightly from a signal noise, an anticipated value may be calculated and used when selecting the respective signal echo. The anticipated value may be based, for example, on the geometry of a load carrier. If this geometry is assisted—even if only slightly—by a plurality of adjacent depth values, the corresponding object is thus regarded as identified. The anticipated value may also be provided by the warehouse floor being illustrated.

According to one embodiment, if the same solid angle has been assigned to a plurality of the signal echoes, one of the signal echoes which previously arrived in the receiving apparatus may be assigned to a second object and this object is identified as partially transparent. As described, with the identification of the first object, the signal echoes which arrived last in the receiving apparatus are evaluated, so that previously arrived signal echoes caused by partially transparent obstacles are ignored. According to this embodiment, however, the partially transparent obstacle as such is also identified, namely by evaluating the previously arriving signal echoes. In particular, the signal echo which arrived first in the receiving apparatus may be assigned to the second object and this object thus identified as partially transparent. The identification of the second object as a partially transparent object may in this case encompass, in particular, that in principle in the case of a plurality of signal echoes, those first arriving are assigned to the partially transparent object. In particular, a view of this second partially transparent object may also be created. Thus, in addition to the aforementioned point cloud for the first object, the evaluation apparatus may create a second point cloud for the second transparent object. Thus, the transparent obstacle may be specifically identified and, if desired, removed in a targeted manner. In principle, therefore, the partially transparent object may be classified more accurately, for example it may be established whether it is a film wrapping of goods or a strip curtain. For example, it may be monitored, when the partially transparent object is a film wrapping of goods, whether the fixing of the goods has given way. Moreover, in principle, further views may be generated, in particular, as point clouds. Thus, a first point cloud could be based on the strongest signal echo and a second point cloud on the second strongest echo. Moreover, a first point cloud could be based on the signal echo furthest to the front when viewed from the industrial truck, whilst a second point cloud could be based on the signal echo located therebehind. In this sense, third, fourth or even further point clouds may also be provided.

According to one embodiment, it may be provided that a speed of the industrial truck is adapted if the object is identified as a strip curtain. In this sense, the industrial truck may be steered on the basis of the identified second object. Thus, the speed of the industrial truck may be reduced so that the industrial truck drives carefully through the strip curtain. Thus, damage to the strip curtain and also the load transported by the industrial truck may be avoided. Moreover, such a speed reduction is expedient since when driving through the strip curtain the object identification of the industrial truck is potentially impaired by the strip curtain. If the partially transparent object, for example, were to be identified as a film wrapping of goods stored on a pallet, the industrial truck is able to puncture this film wrapping when driving the load-carrying fork into the pallet pockets, as already mentioned. An adaptation of the speed of the industrial truck, in particular a reduction of the speed, may also be provided here. This is expedient, in particular, when it is a relatively lightweight load, which could be otherwise displaced by means of the load-carrying fork by puncturing the film in front of the pallet pockets. For example, the industrial truck may be informed that it is a lightweight load via a warehouse management system.

According to one embodiment, the individual movement of the industrial truck is considered when identifying the object. For example, a direction of travel, a driving speed, an acceleration and/or a deceleration of the industrial truck may be considered as an individual movement for the identification of the object. In particular, an object identification may take place repeatedly, for example, at different positions which the industrial truck adopts during the course of its individual movement. Thus, according to one embodiment, a first view of the object is generated on the basis of signal echoes detected in a first position of the industrial truck and compared with a first template, wherein a second view of the object is generated on the basis of signal echoes detected in a second position of the industrial truck and compared with a second template. The object is then regarded as identified when a sufficient correspondence is present both between the first view and the first template and between the second view and the second template. According to this embodiment, therefore, in particular an image sequence with two or more views of the object may be generated and compared with corresponding templates. It may be concluded with greater reliability therefrom whether the signal echoes are caused by a partially transparent object or by a non-transparent object. Thus, possibly occurring multipath reflections, which otherwise may lead to a faulty object identification, may also remain unconsidered. Thus, in the case of multipath reflections it may also lead to a plurality of signal echoes at the same solid angle. With a movement of the industrial truck, however, these multipath reflections generally no longer occur or at least no longer occur at the same solid angle. A partially transparent second object with a non-transparent first object located therebehind, however, will also lead to the arrival of at least two signal echoes at the same solid angle. By considering the individual movement of the industrial truck, it may also be identified whether the alleged signal echo is possibly only a noise. For example, a relatively weak signal echo may also be made plausible by this embodiment and thus distinguished from the noise. If the pixel resulting from the signal echo moves in harmony with the individual movement of the industrial truck, it is probably an object worthy of identification and not noise.

The industrial truck may be steered on the basis of the identified object, as already discussed. Thus, according to one embodiment, the industrial truck may be automatically oriented on the basis of the identified object. As already discussed, the industrial truck for example may drive automatically with the load-carrying fork into pallet pockets of the pallet, even if these pallet pockets are concealed by a partially transparent film. Moreover, the industrial truck could automatically drive through a partially transparent strip curtain. Partially automatic steering is also conceivable. Thus, according to one embodiment, an orientation or movement of the industrial truck to be carried out or to be initiated by an operator of the industrial truck on the basis of the identified object may be optically and/or acoustically displayed to the operator. The industrial truck may comprise corresponding display devices. For example, it could be displayed to the operator on a display how the load-carrying fork is to be oriented, in order to permit picking up a pallet. An acoustic feedback could be implemented in the case of a correct orientation. In a partially automated case, it could be optically or acoustically displayed that a pallet has been identified and that the industrial truck is ready for the corresponding orientation. An automatic orientation of the industrial truck could thus be carried out by an interaction of the operator with the industrial truck, for example by holding down a corresponding operating element.

According to one embodiment, environmental elements are considered for the identification of the object. Thus, it could be concluded from the environment in which the object generally is to be anticipated whether the known signal echoes are actually the object. Thus, for example, the wall behind a storage area may be an indication that detected signal echoes actually originate from a pallet located on the storage area. The wall may also provide an indication as to where a corresponding signal echo is highly likely to be found.

### BRIEF DESCRIPTION OF THE DRAWINGS

The invention is described hereinafter with reference to figures, in which:

FIG. 1 a schematically illustrates a top plan view of an embodiment of an industrial truck;

FIG. 1b schematically illustrates a side view of an embodiment of the industrial truck;

FIG. 2a schematically illustrates an embodiment of an identification stage of a pallet by template matching;

FIG. 2b schematically illustrates another embodiment of the identification stage of FIG. 2a;

FIG. 3a schematically illustrates an embodiment of a failed identification stage of the pallet due to pallet pockets concealed by partially transparent film;

FIG. 3a schematically illustrates another embodiment of the failed identification stage of FIG. 3a.

FIG. 4 schematically illustrates an embodiment of a pallet identification;

FIG. 5 schematically illustrates another embodiment of a pallet identification;

FIG. 6 schematically illustrates a view of production of signal echoes;

FIG. 7 schematically illustrates an embodiment of a free space in a storage rack; and

FIG. 8 schematically illustrates an embodiment of an industrial truck driving through a partially transparent strip curtain.

Unless indicated otherwise, the same reference numerals denote the same objects hereinafter.

### DETAILED DESCRIPTION OF THE INVENTION

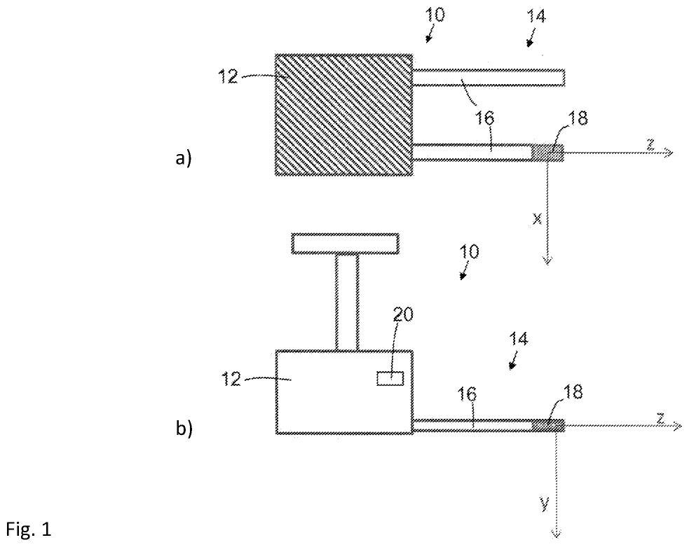

FIGS. 1a, 1b show an industrial truck 10 according to the invention, wherein the industrial truck 10 in FIG. 1a is shown in a view from above and in FIG. 1b in a view from the side. The industrial truck 10 comprises a drive part 12 and a load part 14. The load part 14 has a load-carrying fork with two fork tines 16. A sensor unit 18 as a transceiving apparatus is arranged in the tip of one of the fork tines 16, said sensor unit emitting identification signals and detecting identification signals as signal echoes reflected by objects in the environment of the industrial truck 10. The sensor unit 18 may have, for example, a 2D or 3D LIDAR system. The sensor unit may also be arranged at a different position, for example on a mast of the industrial truck.

On the basis of the signal echoes received by the sensor unit 18 an evaluation apparatus 20 arranged in the drive part 12 of the industrial truck 10 generates views of objects located in the environment of the industrial truck. The evaluation apparatus 20 compares these views with stored templates, wherein in the case of sufficient correspondence between the respective view and the respective template, the object forming the basis of the template is regarded as identified. Such a template matching is described in detail in EP 3 316 181 A1.

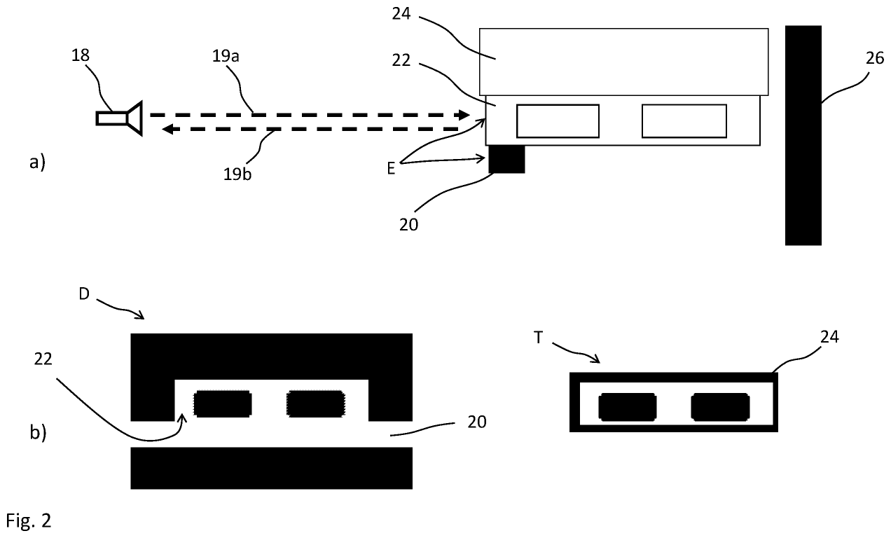

In FIG. 2a it may be seen that the sensor unit 18 emits identification signals 19a and receives a reflected identification signal 19b as a signal echo. In the view visible in FIG. 2a, the load-carrying fork of the industrial truck is lifted to the height of a pallet 22 being stored on a rack support 20. The pallet 22 has a load 24. Additionally, a rack rear wall 26 is visible. The sensor unit 18 emits a plurality of identification signals 19a at different solid angles, wherein reflections occur on the pallet 22 and on the rack support 20. Thus, signal echoes with the reference numeral E are produced and the view visible in FIG. 2b results. This view shows in white the image of the rack front generated from the signal echoes E, together with a front of the pallet 22 and a front of the rack support 20. Shown in black are the surrounding regions, for which either no signal echoes have been received or the signal echoes thereof are not shown. Thus, in particular, the load 24 could also be visible in the view D, but is not shown. Clearly visible in the view D are the two rectangular pallet pockets of the pallet 22. The rack rear wall 26 located behind the pallet in principle also generates a signal echo. However, this has not been considered for the object identification. This may be achieved, for example, by only signal echoes which arrive within a predetermined time period after the emission of the identification signal in the sensor unit 18 being used for the identification of the object. The view D visible in FIG. 2b is compared with the template T, visible to the right in FIG. 2b. The template T is stored as a pattern image of a pallet front in the evaluation apparatus 20. With sufficient correspondence between the view D and the template T the evaluation apparatus 20 identifies the pallet 22 as such. In the present example, the view of the front of the pallet 22 is free so that the view D and template T correspond well, and the pallet may be identified. However, it may arise that the view of the front of the pallet is concealed, for example, by a partially transparent film which is regularly used for fixing loads arranged on the pallet.

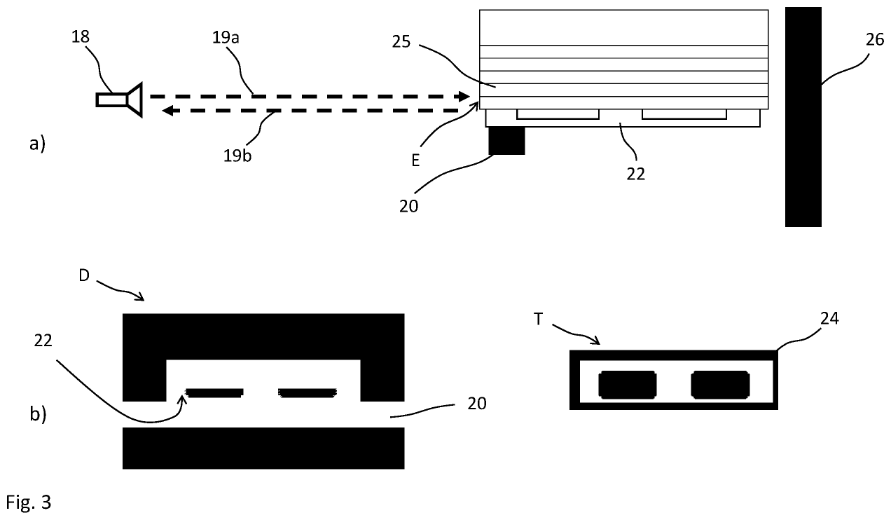

This is shown in FIG. 3a. Here the goods 24 are wrapped around with a partially transparent film 25. As may be seen, the film 25 protrudes downwardly beyond the goods and also surrounds the pallet 22 such that the pallet pockets are partially covered. Identification signals 19a emitted from the sensor unit 18 are at the same time reflected on the film 25 so that by known identification methods the image visible in FIG. 3b results. This view of the pallet 22 deviates from the template T, shown again to the right in FIG. 3b, to such an extent that the pallet 22 as such is not identified. At this point the invention comes into play.

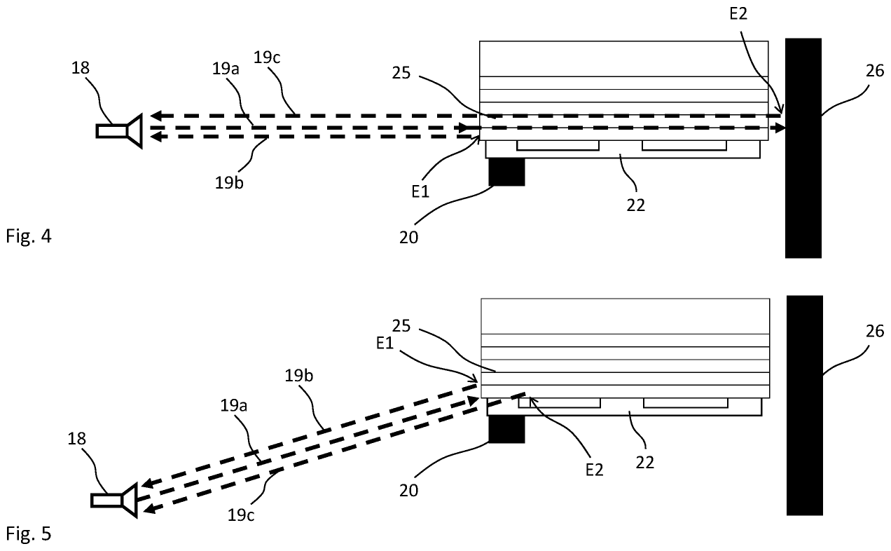

As the inventors have recognized, the partial transparency of the film 25 leads to repeated signal echoes at the same solid angle. As shown in FIG. 4, only a first portion of the identification signals 19a is reflected on the film 25 as a signal 19b, whilst a second portion of the identification signals 19a passes through the film, passes the pallet pockets located therebehind and is reflected on the rack rear wall 26 as a signal 19c. Thus, first signal echoes E1 are produced on the pallet front and the film 25 located there, as well as second signal echoes E2 on the rack rear wall 26. Thus, a plurality of signal echoes at the same solid angle reach the sensor unit 18, namely at least the signal echoes E1 and E2. In principle, even more signal echoes may be identified, for example by a reflection of the identification signal on the film 25 located on the rear face of the pallet 22. According to the invention, it is provided that for the solid angle to which a plurality of echoes have been assigned, only the signal echoes which arrived last in the sensor unit 18 are evaluated for the identification of the object. Thus, in the present example only the signal echo E2 forms the basis of the object identification, but not the signal echo E1. Thus, to a certain extent it is possible to see through the partially transparent film 25. In spite of the concealment of the pallet pockets by the film 25 a complete front image of the pallet 22, as shown to the left in FIG. 2b, is thus produced. Thus, the template matching may be carried out successfully with the template T and the object identified as a pallet.

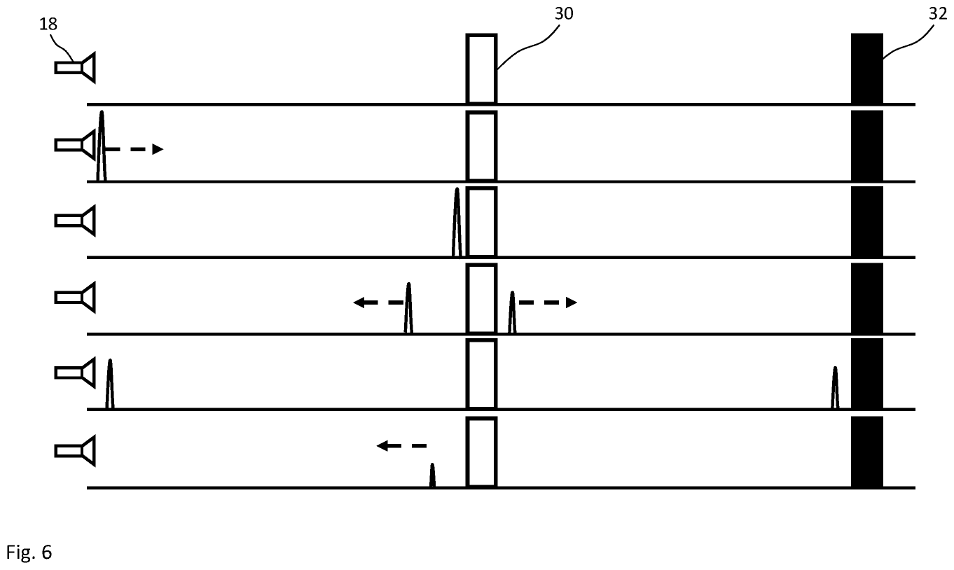

In FIG. 5 the sensor unit 18 is arranged at a lower height than the pallet 22.

However, the pallet 22 may also be already identified successfully here. In this arrangement the second echo E2 results from a reflection of the identification signal on a lower face of the pallet top deck. Accordingly, the view D from FIG. 2b at the left may also be produced again here. Thus, during the evaluation according to the invention of the second echo E2 it leads once again to the successful identification of the pallet, since sufficient correspondence of the view with the template is present.

FIG. 6 shows schematically the signal path. Signal peaks emitted and received by the sensor unit 18 may be identified. A signal peak is emitted as an identification signal by the sensor unit 18, and encounters a transparent object 30 so that the signal is partially reflected and partially transmitted. The reflected part first passes back to the sensor unit 18 and is registered as the first signal echo. The transmitted part is fully reflected on a non-transparent object 32, in turn partially passes through the transparent object 30 and then reaches the sensor unit 18 again where it is registered as the second signal echo.

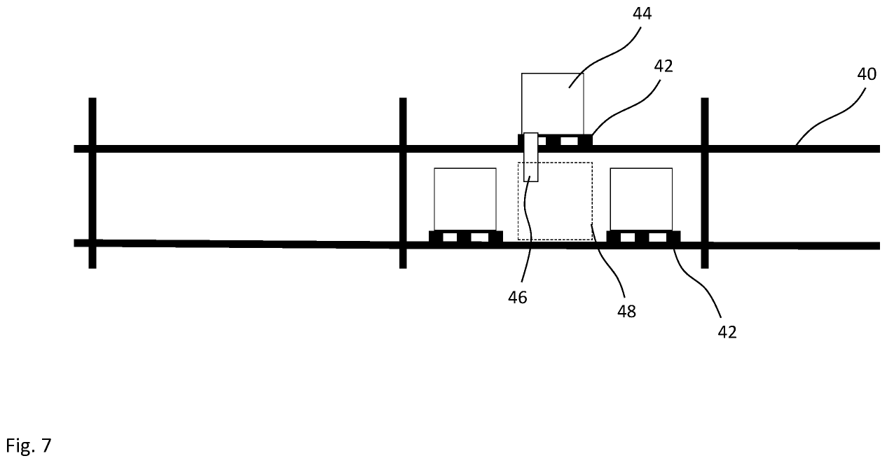

In FIG. 7 a further application for the method according to the invention is shown. A front view of a rack 40 with load carriers 42 located therein, also configured as pallets, is visible. The pallet 42 arranged on the upper rack level bears a load with film wrapping 44, wherein a part 46 of the film wrapping 44 protrudes downwardly into the rack level located therebelow. This film part 46 thus interrupts the identification of a free space 48 by the industrial truck 10. Thus, in the known methods, the part 46 of the film 44 hanging down is identified as an obstacle and thus the pallet space is not identified as free. Due to the method according to the invention, however, in the manner described above, by evaluating the signal echo arriving last it is possible to see through the part 46 of the film 44 hanging down and thus the free space 48 may be identified as such. Then a load carrier may be unloaded in this free space, without having to take account of the part 46 hanging down.

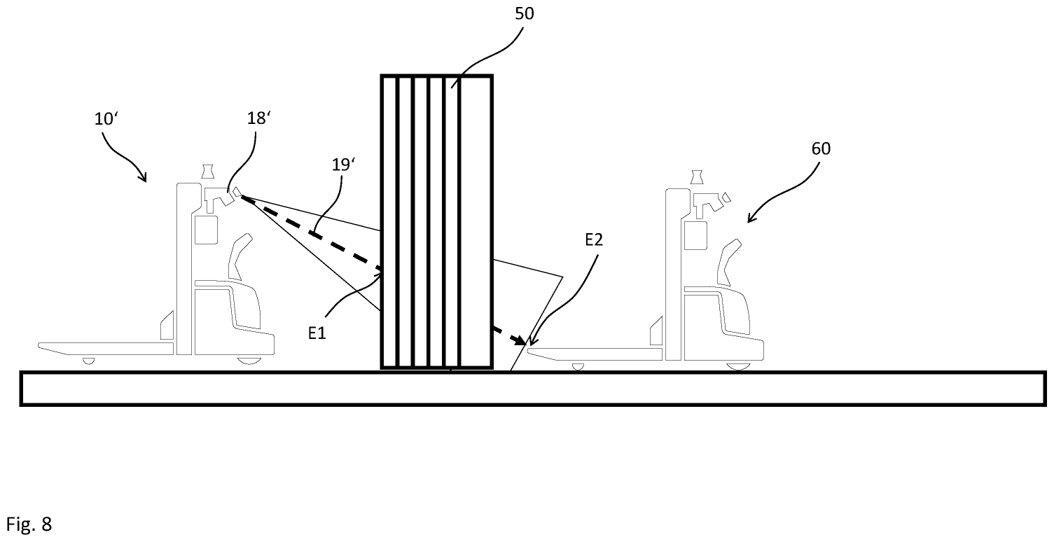

FIG. 8 shows an industrial truck 10′ when driving through a partially transparent strip curtain 50. The industrial truck 10′ has a sensor unit 18′ which observes a floor located upstream of the industrial truck in the direction of travel of the industrial truck 10′. Identification signals 19′ emitted from the sensor unit 18′ in this case generate a first echo E1 at the partially transparent strip curtain 50 and a further echo E2 at a second industrial truck 60 located downstream of the strip curtain 50. By evaluating the second echo E2 the industrial truck 10′ thus is able to see through the strip curtain 50 and identify the industrial truck 60 located therebehind. Additionally, it is identified that the strip curtain 50 itself does not form an obstacle, so that the industrial truck 10′ is able to pass through said strip curtain. Should a second industrial truck not be located behind the strip curtain, for example, the floor region located downstream of the strip curtain could be identified as an object.

### LIST OF REFERENCE NUMERALS

10 Industrial truck
10′ Industrial truck
12 Drive part
14 Load part
16 Fork tines
18 Sensor unit
18′ Sensor unit
19a Identification signal
19b Reflected identification signal
19c Reflected identification signal
19′ Identification signal
20 Rack support
22 Pallet
24 Load
25 Partially transparent film
26 Rack rear wall
30 Transparent object
32 Non-transparent object
40 Rack
42 Load carrier
44 Film wrapping
46 Part of film wrapping
48 Free space
50 Partially transparent strip curtain
60 Second industrial truck
D View
Template
E1 First signal echo
E2 Second signal echo

1. A method for identifying objects in a warehouse using an industrial truck, the method comprising:
emitting an identification signal into an environment using a transmitting apparatus positioned on the industrial truck;
detecting reflected identification signals by objects in the environment as a signal echo using a receiving apparatus positioned on the industrial truck;
assigning a solid angle and a receiving time to each of the signal echoes;
determining whether a same solid angle has been assigned to a plurality of signal echoes;
evaluating the signal echo which arrived last in the receiving apparatus according to a receiving time for the same solid angle when a plurality of signal echoes have been assigned to the same solid angle; and
identifying the object based on the evaluated signal echoes.

2. The method according to claim 1, wherein signal echoes which arrive in the receiving apparatus outside a predetermined time period after the emission of the identification signal are not evaluated for purposes of identifying the object.

3. The method according to claim 2, wherein the predetermined time period is based on a maximum measuring distance to be anticipated.

4. The method according to claim 1, wherein identifying the object based on the evaluated signal echoes comprises,
generating a view of the object based on the signal echoes, and
comparing the view with a template,
wherein the object is identified when there is sufficient correspondence between the view and the template.

5. The method according to claim 4, wherein the generating the view of the object comprises creating a two-dimensional data set by projecting pixels onto a projection plane.

6. The method according to claim 5, further comprising,
creating a further data set which comprises a depth profile along a line at a position of the projection plane,
comparing the further data set with a predefined depth profile pattern assigned to the object, and
identifying the object when a sufficient correspondence is established during the comparing.

7. The method according to claim 1, further comprising, when a plurality of signal echoes per same solid angle are determined,
assigning a signal echo, which arrived in the receiving apparatus before the signal echo which arrived last in the receiving apparatus, to a second object, and
identifying the second object as a partially transparent object.

8. The method according to claim 7, wherein the second object is identified as one of a: (1) film; and (2) strip curtain.

9. The method according to claim 8, wherein a speed of the industrial truck is adjusted if the second object is identified as one of: (1) a film; and (2) a strip curtain.

10. The method according to claim 1, wherein the identifying of the object further considers individual movement of the industrial truck.

11. The method according to claim 1, wherein the identifying of the object comprises,
generating a first view of the object based on signal echoes detected in a first position of an industrial truck,
comparing the first view with a first template,
generating a second view of the object based on signal echoes detected in a second position of the industrial truck,
comparing the second view with a second template, and
identifying the object if there is sufficient correlation between: (1) the first view and the first template; and (2) the second view and second template.

12. The method according to claim 1, wherein steering of the industrial truck is accomplished by automatic orientation of the industrial truck based on the identified object.

13. The method according to claim 12, further comprising generating at least one of an (1) optical and (2) an acoustic displays of an orientation of the industrial truck to be carried out by an operator of the industrial truck based on the identified object.

14. The method according to claim 1, wherein identifying the object further considers surrounding environmental elements.

15. An industrial truck comprising:
a transmitting apparatus configured to emit an identification signal into an environment;
a receiving apparatus configured to detect the identification signal as a signal echo reflected by objects in the environment; and
an evaluation apparatus configured to,
assign a solid angle and a receiving time to each of the signal echoes,
determine whether a same solid angle has been assigned to a plurality of the signal echoes,
when a same solid angle has been assigned to a plurality of the signal echoes, evaluate the signal echo which arrived last in the receiving apparatus according to the receiving time for the solid angle for identification of the object,
identify the object based on the signal echo, and
steer the industrial truck based on the identified object.
